(19) United States
(12) Patent Application Publication
(10) Pub. No.: US 2026/0268107 A1
(43) Pub. Date: Sep. 10, 2026

(54) INFORMATION PROCESSING SYSTEM, NON-TRANSITORY COMPUTER READABLE MEDIUM AND METHOD

(71) Applicant: FUJIFILM Business Innovation Corp., Tokyo (JP)

(72) Inventor: Minoru AKIYAMA, Kanagawa (JP)

(73) Assignee: FUJIFILM Business Innovation Corp., Tokyo (JP)

(21) Appl. No.: 19/334,138

(22) Filed: Sep. 19, 2025

(30) Foreign Application Priority Data
Mar. 10, 2025 (JP) 2025-037259

(51) Int. Cl. G06K 15/00; G06K 15/02; H04N 1/52

(52) U.S. Cl. CPC G06K 15/4045; G06K 15/1836; G06K 15/1881; H04N 1/52

(57) ABSTRACT

An information processing system includes an image forming system and a log acquisition system, in which the image forming system includes: an image outputter; and a first processor configured to: perform multiple image processing operations that convert print data, input to the image forming system, into image data that the image outputter outputs to a recording medium, while calculating and successively outputting a first feature value externally that is used to confirm data identity of process data that is generated at an operation phase of each of the image processing operations; and in which the log acquisition system includes a second processor configured to: perform, on print data identical to the print data input to the image forming system, multiple image processing operations respectively identical to the image processing operations performed by the image forming system, while calculating a second feature value that is used to confirm data identity of process data that is generated at an operation phase of each of the image processing operations; acquire from the image forming system the first feature value at the operation phase of each of the image processing operations; and when the acquired first feature value is different from the second feature value, acquire, from the image forming system, data used to analyze the image processing operations and store the data as history information.

### CROSS-REFERENCE TO RELATED APPLICATIONS

This application is based on and claims priority under 35 USC 119 from Japanese Patent Application No. 2025-037259 filed Mar. 10, 2025.

### BACKGROUND

### (i) Technical Field

The present disclosure relates to an information processing system, a non-transitory computer readable medium and a method.

### (ii) Related Art

Japanese Unexamined Patent Application Publication No. 10-116258 discloses a fault-tolerant computer system that includes multiple internal modules, each including a circuit generating a signature, and determines, in response to an output difference, which internal module malfunctions.

Japanese Patent No. 3078972 discloses a disk array apparatus that, if multiple disk devices operating in parallel simultaneously malfunction, may quickly handle a process request without data loss.

Japanese Unexamined Patent Application Publication No. 2002-186175 discloses a power supply in which multiple power modules operate in parallel. When one of the power modules malfunctions, the power supply has a mechanism that isolates the malfunctioning power module from a power cage in response to a signal generated by a failure detection circuit.

Japanese Unexamined Patent Application Publication No. 2020-102100 discloses a log acquisition apparatus that enables log data to be easily retrieved to improve maintainability when a communication device, such as a router, malfunctions.

A log acquisition apparatus acquires and stores history information on an image forming process and when an image forming apparatus malfunctions in the image forming process, a cause of the malfunction is analyzed in retrospect. The log acquisition apparatus is designed to acquire history information from the image forming apparatus when the image forming process is interrupted with the image forming apparatus malfunctioning. Even when the image forming apparatus normally finishes the image forming process, a malfunction, such as abnormal color of a resulting image or white knockout, may occur and the history information on the image forming process may not be acquired.

### SUMMARY

Aspects of non-limiting embodiments of the present disclosure relate to providing information processing system, a non-transitory computer readable medium and a method that enable history information on an image forming process to be available when an obtained image has a fault even with the image forming process normally completed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: an image forming system and a log acquisition system, wherein the image forming system includes: an image outputter; and a first processor configured to: perform multiple image processing operations that convert print data, input to the image forming system, into image data that the image outputter outputs to a recording medium, while calculating and successively outputting a first feature value externally that is used to confirm data identity of process data that is generated at an operation phase of each of the image processing operations; and wherein the log acquisition system includes a second processor configured to: perform, on print data identical to the print data input to the image forming system, multiple image processing operations respectively identical to the image processing operations performed by the image forming system, while calculating a second feature value that is used to confirm data identity of process data that is generated at an operation phase of each of the image processing operations; acquire from the image forming system the first feature value at the operation phase of each of the image processing operations; and when the acquired first feature value is different from the second feature value, acquire, from the image forming system, data used to analyze the image processing operations and store the data as history information.

### BRIEF DESCRIPTION OF THE DRAWINGS

Exemplary embodiment of the present disclosure will be described in detail based on the following figures, wherein:

FIG. 1 illustrates the system configuration of an information processing system in an exemplary embodiment of the disclosure;

FIG. 2 is a block diagram illustrating the hardware configuration of an image forming apparatus in the exemplary embodiment of the disclosure;

FIG. 3 is a block diagram illustrating the hardware configuration of a log acquisition apparatus in the exemplary embodiment of the disclosure;

FIG. 4 is a block diagram illustrating the functional configuration of the image forming apparatus in the exemplary embodiment of the disclosure;

FIG. 5 is a block diagram illustrating the functional configuration of the log acquisition apparatus in the exemplary embodiment of the disclosure;

FIG. 6 is a flowchart illustrating the process of the image forming apparatus in a printing operation;

FIG. 7 is a sequence chart illustrating how the log acquisition apparatus stores a checksum and pixel count value transmitted from the image forming apparatus to the log acquisition apparatus;

FIG. 8 is a flowchart illustrating the process performed by the log acquisition apparatus 20 that calculates the checksum and pixel count value; and

FIG. 9 is a flowchart illustrating the process of the log acquisition apparatus that acquires log data from the image forming apparatus.

### DETAILED DESCRIPTION

Embodiment of the disclosure is described with reference to the drawings.

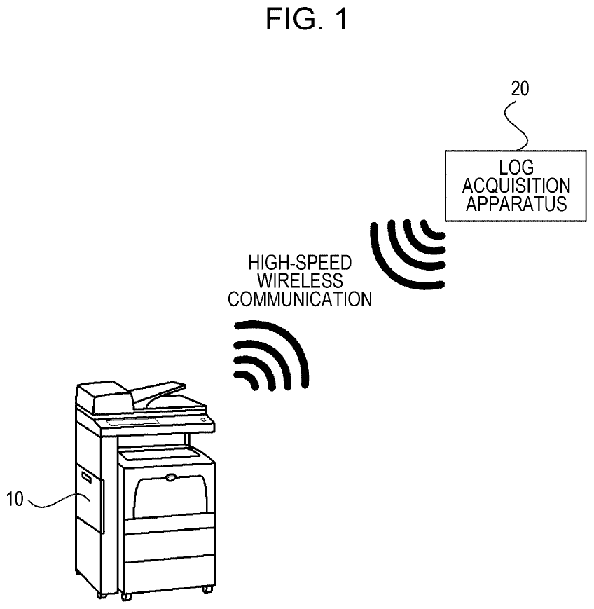

FIG. 1 illustrates the system configuration of an information processing system in an exemplary embodiment of the disclosure.

The image forming system of the exemplary embodiment of the disclosure includes an image forming apparatus 10 and log acquisition apparatus 20 as illustrated in FIG. 1. The image forming apparatus 10 is a multi-function apparatus having multiple functions including a print function, scanning function, copying function, and fax function. The image forming apparatus 10 receives print data transmitted from a terminal apparatus (not illustrated) and outputs to a paper sheet an image responsive to the received print data. When the image forming apparatus 10 malfunctions, the log acquisition apparatus 20 receives from the image forming apparatus 10 log data used to analyze the cause of the malfunction. The image forming apparatus 10 is connected to the log acquisition apparatus 20 using a high-speed wireless communication network, such as 5th Generation Mobile Communication System (5G).

The information processing system of the exemplary embodiment is configured as described below and, even when a malfunction, such as abnormal color of a resulting image or white knockout, occurs even with the image forming process normally completed on the image forming apparatus 10, log data on the image forming process may be acquired as history information and stored on the log acquisition apparatus 20.

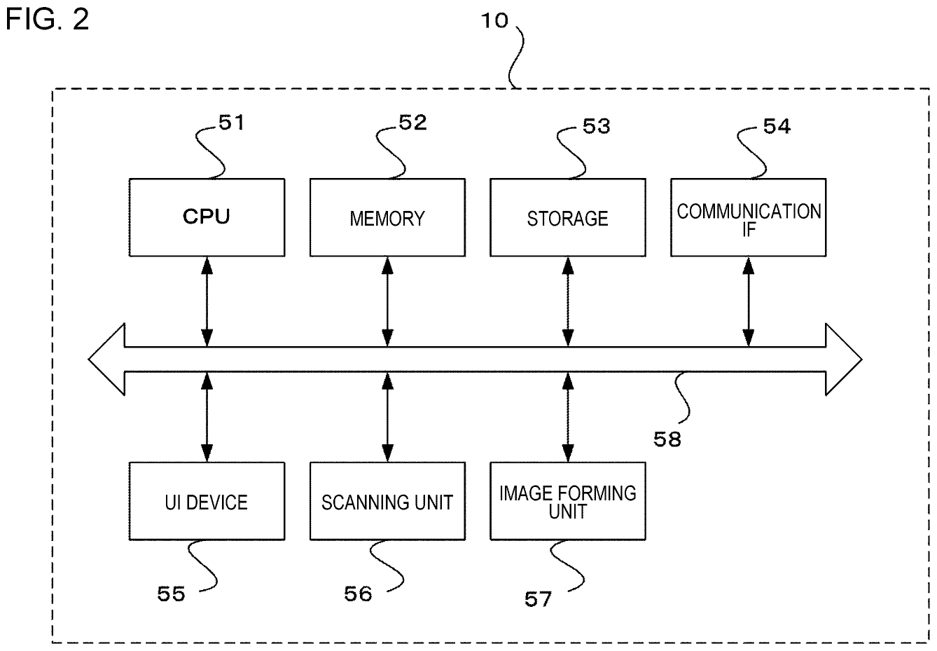

FIG. 2 is a block diagram illustrating the hardware configuration of the image forming apparatus 10 in the information processing system in the exemplary embodiment of the disclosure.

Referring to FIG. 2, the image forming apparatus 10 includes a central processing unit (CPU) 51, memory 52, storage 53, such as a hard disk drive, communication interface (IF) 54 that transmits or receives data to or from an external device via wired or wireless network, user interface (UI) device 55 that includes a touch panel or a liquid-crystal display and keyboard, scanning unit 56, and image forming unit 57. Those elements are interconnected to each other via a control bus 58.

The image forming unit 57 prints an image on a recording medium, such as a paper sheet, through charging, exposure, development, transfer and fixing.

The CPU 51 controls the process of the image forming apparatus 10 by performing a specific process in accordance with a control program stored on the memory 52 or the storage 53. According to the exemplary embodiment, the CPU 51 retrieves the control program from the memory 52 or storage 53 and executes the retrieved control program. The disclosure is not limited to this method. The control program may be supplied in a recorded form on a computer readable recording medium. For example, the control program may be supplied in a recorded form on an optical disc, such as a compact disc (CD) read-only memory (ROM) or digital versatile disc (DVD)-ROM, or in a recorded form on a semiconductor memory, such as a universal serial bus (USB) memory or a memory card. Alternatively, the control program may be delivered from an external device via a communication network connected to the communication IF 54. The control program may be supplied as a standalone application or may be built in software of each device serving as a function of the image forming apparatus 10.

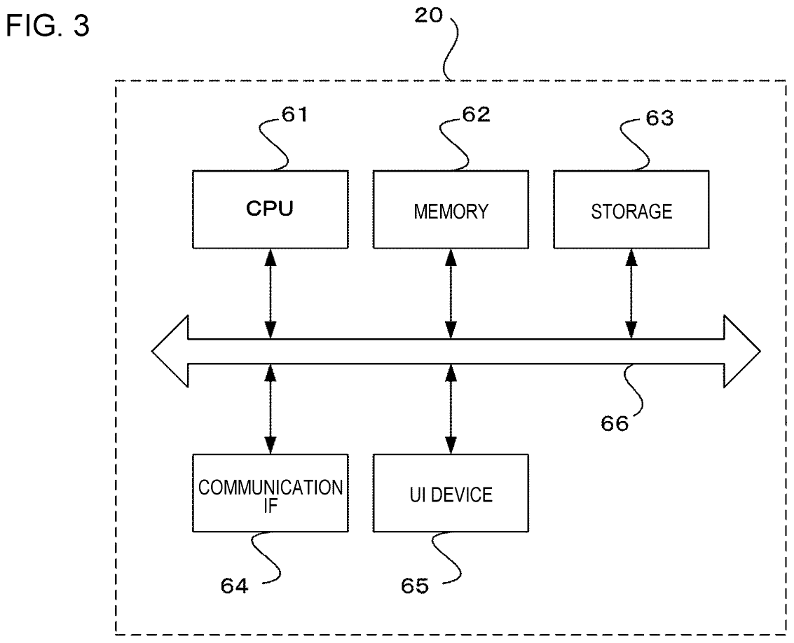

FIG. 3 is a block diagram illustrating the hardware configuration of the log acquisition apparatus 20 in the information processing system of the exemplary embodiment.

Referring to FIG. 3, the log acquisition apparatus 20 includes a central processing unit (CPU) 61, memory 62, storage 63, such as a hard disk drive, communication interface (IF) 64 that transmits or receives data to or from an external device via wired or wireless network, and user interface (UI) device 65 that includes a touch panel or a liquid-crystal display and keyboard. Those elements are interconnected to each other via a control bus 66.

The CPU 61 controls the process of the log acquisition apparatus 20 by performing a specific process in accordance with a control program stored on the memory 62 or the storage 63. According to the exemplary embodiment, the CPU 61 retrieves the control program from the memory 62 or storage 63 and executes the retrieved control program. The disclosure is not limited to this method. The control program may be supplied in a recorded form on a computer readable recording medium. For example, the control program may be supplied in a recorded form on an optical disc, such as a CD-ROM or DVD-ROM, or in a recorded form on a semiconductor memory, such as a USB memory or memory card. Alternatively, the control program may be delivered from an external device via a communication network connected to the communication IF 64. The control program may be supplied as a standalone application or may be built in software of each device serving as a function of the log acquisition apparatus 20.

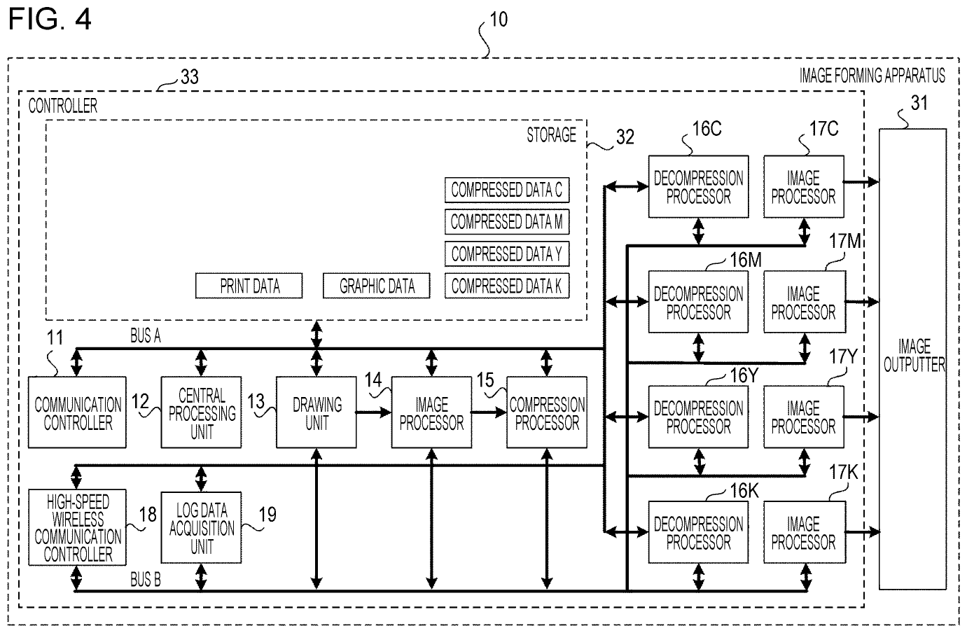

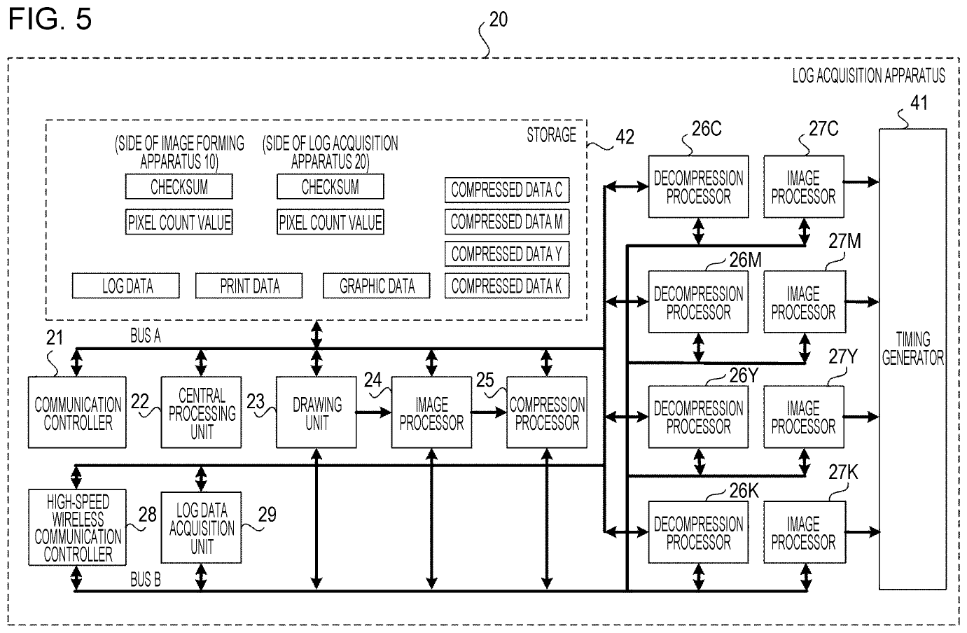

FIGS. 4 and 5 are block diagrams illustrating the functional configurations of the image forming apparatus 10 and the log acquisition apparatus 20 that are implemented by executing the control programs.

FIG. 4 is the block diagram illustrating the functional configuration of the image forming apparatus 10.

Referring to FIG. 4, the image forming apparatus 10 of the exemplary embodiment includes an image outputter 31 and controller 33. The controller 33 includes a communication controller 11, central processing unit 12, drawing unit 13, image processor 14, compression processor 15, decompression processors 16C, 16M, 16Y, and 16K, image processors 17C, 17M, 17Y, and 17K, high-speed wireless communication controller 18, log data acquisition unit 19, and storage 32. The decompression processors 16C, 16M, 16Y, and 16K are identical to each other except for color that is handled by each decompression processor and each decompression processer is simply referred to as a decompression processor 16 when those elements are not differentiated from each other. The image processors 17C, 17M, 17Y, and 17K are identical to each other except for color that is handed by each image processor and each image processor is simply referred to as an image processor 17 when those elements are not differentiated from each other.

FIG. 5 is a block diagram illustrating the functional configuration of the log acquisition apparatus 20.

Referring to FIG. 5, the log acquisition apparatus 20 of the exemplary embodiment includes a timing generator 41, communication controller 21, central processing unit 22, drawing unit 23, image processor 24, compression processor 25, decompression processors 26C, 26M, 26Y, and 26K, image processors 27C, 27M, 27Y, and 27K, high-speed wireless communication controller 28, log data acquisition unit 29, and storage 42. The decompression processors 26C, 26M, 26Y, and 26K are identical to each other except for color that is handled by each decompression processor and each decompression processor is simply referred to as a decompression processor 26 when those elements are not differentiated from each other. The image processors 27C, 27M, 27Y, and 27K are identical to each other except for color that is handed by each image processor and each image processor is simply referred to as an image processor 27 when those elements are not differentiated from each other.

As illustrated in FIGS. 4 and 5, the log acquisition apparatus 20 is identical in configuration to the controller 33 in the image forming apparatus 10. The log acquisition apparatus 20 includes the timing generator 41 generating a synchronization signal in place of the image outputter 31 in the image forming apparatus 10.

The log acquisition apparatus 20 thus configurated may perform the same image forming process as the image forming process of the image forming apparatus 10.

The central processing unit 12 in the image forming apparatus 10 of the exemplary embodiment performs multiple image processing operations that serves to convert the print data input from an terminal device into image data that the image outputter 31 outputs to a recording medium, such as a paper sheet. The central processing unit 12 in the image forming apparatus 10 calculates a first feature value that serves to confirm identity of the process data generated at the operation phase of each of the image processing operations and then sequentially outputs the first feature value to the log acquisition apparatus 20.

The central processing unit 22 in the log acquisition apparatus 20 performs, on the same print data as the print data input to the image forming apparatus 10, multiple image processing operations respectively identical the image processing operations performed by the image forming apparatus 10. The central processing unit 22 in the log acquisition apparatus 20 calculates a second feature value that is used to confirm identity of the process data generated at the operation phase of each of the image processing operations. The central processing unit 22 then acquires the first feature value at the operation phase of each of the image processing operations from the image forming apparatus 10 and stores the first feature value on the storage 42. When the first feature value is different from the second feature value, the central processing unit 22 determines that the image forming apparatus 10 malfunctions in the image forming process. The central processing unit 22 then acquires data used to analyze the image processing operations from the image forming apparatus 10 and the stores the data on the storage 42.

According to the exemplary embodiment, a value calculated by performing a calculation operation on the process data through a predetermined calculation method is used as the first feature value calculated in the image forming apparatus 10. The second feature value calculated by the log acquisition apparatus 20 is a value calculated by performing the same calculation operation as the calculation operation through the calculation method the image forming apparatus 10 has used on the process data.

Specifically, each of the first feature value and second feature value is a checksum resulting from accumulating the process data or a pixel count value that is a density cumulative value resulting from accumulating the density value of each pixel. Note that the first feature value and second feature value are not limited to the checksum or pixel count value. For example, a hash value that is calculated through a predetermined hash function may be used as the first feature value and second feature value.

The multiple image processing operations performed by the image forming apparatus 10 and log acquisition apparatus 20 convert the print data into raster image data that is used to cause image forming units of CMYK (cyan, magenta, yellow, and black) colors forming the image outputter 31 to output an image on a paper sheet.

The image processing operations to convert the print data into the raster image data include a color conversion operation to convert the print data into image data of each of the CMYK colors to be used by the image outputter 31 and a halftone operation to represent halftone.

Note that the central processing unit 22 in the log acquisition apparatus 20 controls the high-speed wireless communication controller 28 to acquire the first feature value at the operation phase of each of the image processing operations from the image forming apparatus 10 via high-speed wireless communication network.

The log acquisition apparatus 20 performs the same process as the process of the image forming apparatus 10 to calculate the checksum or pixel count value of the process data at the operation phase of each of the image processing operations. By determining whether the calculated checksum and pixel count value match the checksum and pixel count value successively acquired from the image forming apparatus 10, the log acquisition apparatus 20 recognizes whether the image forming apparatus 10 malfunctions in the image forming process. Upon determining that the image forming apparatus 10 malfunctions in the image forming process, the log acquisition apparatus 20 requests the image forming apparatus 10 to transmit the process data in the middle of the image forming process. The log acquisition apparatus 20 stores on the storage 42 the process data as the log data transmitted from the image forming apparatus 10.

When a malfunction, such as abnormal color of a resulting image or white knockout, occurs even with the image forming process normally completed on the image forming apparatus 10, log data on the image forming process may be stored as the log data on the log acquisition apparatus 20.

The processes of the image forming apparatus 10 and log acquisition apparatus 20 of the exemplary embodiment are described in detail with reference to the drawings.

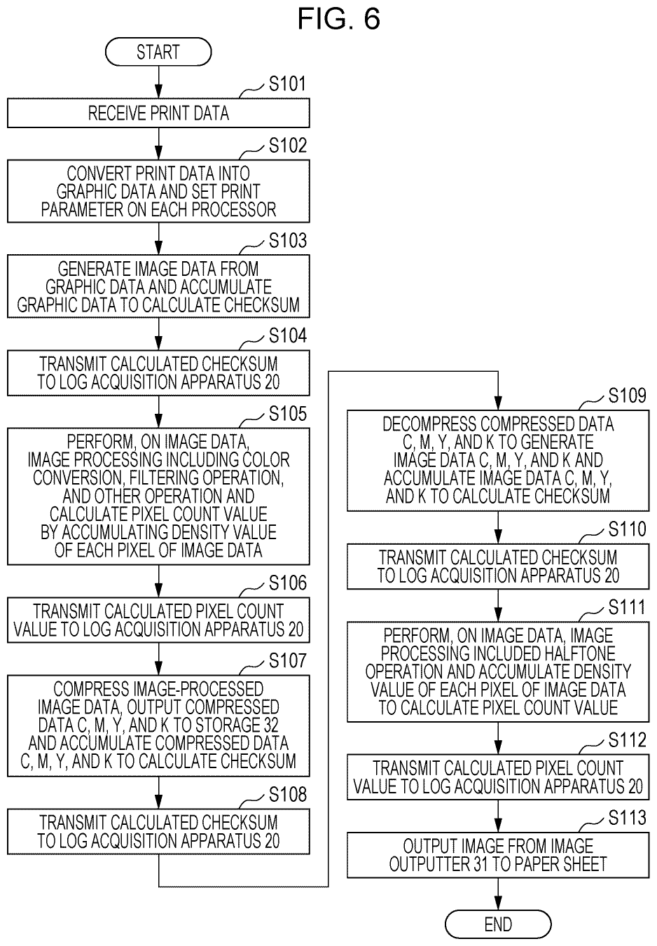

The process of each processor in the image forming apparatus 10 is described in detail with reference to FIG. 6.

In step S101, the communication controller 11 causes the storage 32 to store print data received from outside. In step S102, the central processing unit 12 analyzes the received print data and generates and stores graphic data on the storage 32 while setting a parameter on each processor.

In step S103, the drawing unit 13 generates image data from the graphic data generated by the central processing unit 12 and outputs the image data to the image processor 14. The drawing unit 13 then accumulates the graphic data to calculate the checksum and output the calculated checksum to the log data acquisition unit 19 via a bus B. In step S104, the log data acquisition unit 19 transmits the checksum to the log acquisition apparatus 20 via the high-speed wireless communication controller 18.

In step S105, the image processor 14 performs on the image data transmitted from the drawing unit 13 image processing operations including a color conversion operation and a filtering operation and outputs image-processed image data to the compression processor 15. The image processor 14 further calculates a pixel cunt value by accumulating the density value of each pixel of the image data prior to and subsequent to the image processing operations, and outputs the calculated pixel count value to the log data acquisition unit 19 via the bus B. The log data acquisition unit 19 transmits the pixel count value to the log acquisition apparatus 20 via the high-speed wireless communication controller 18 in step S106.

In step S107, the compression processor 15 compresses the image data transmitted from the image processor 14 and causes the storage 32 to store the compressed image data. At that time point, the process data color-converted through the color conversion operation performed by the image processor 14 includes four pieces of image data of respective CMYK colors and four pieces of compressed data C, M, Y, and K are thus stored on the storage 32. The compression processor 15 calculates the checksum by accumulating the four pieces of compressed data C, M, Y, and K and outputs the checksum to the log data acquisition unit 19 via the bus B. In step S108, the log data acquisition unit 19 transmits the checksum to the log acquisition apparatus 20 via the high-speed wireless communication controller 18.

In step S109, the decompression processors 16C, 16M, 16Y, and 16K decompress the compressed data C, M, Y, and K stored on the storage 32 and outputs the decompressed image data respectively to the image processors 17C, 17M, 17Y, and 17K. The decompression processors 16C, 16M, 16Y, and 16K thus calculate the checksum by accumulating the decompressed image data C, M, Y, and K and outputs the calculated checksum to the log data acquisition unit 19 via the bus B. The log data acquisition unit 19 transmits the checksum to the log acquisition apparatus 20 via the high-speed wireless communication controller 18 in step S110.

In step S111, the image processors 17C, 17M, 17Y, and 17K perform image processing operations including a halftone operation on the decompressed image data C, M, Y, and K respectively transmitted from the decompression processors 16C, 16M, 16Y, and 16K and outputs the image-processed image data C, M, Y, and K to the image outputter 31. The image processors 17C, 17M, 17Y, and 17K further calculate the pixel count value by accumulating the density value of each pixel of the image data prior to and subsequent to the image processing operations and outputs the calculated pixel count value to the log data acquisition unit 19 via the bus B. In step S112, the log data acquisition unit 19 transmits the pixel count value to the log acquisition apparatus 20 via the high-speed wireless communication controller 18.

In step S113, the image outputter 31 performs a printing operation in accordance with the image data C, M, Y, and K of the four colors transmitted from the image processors 17C, 17M, 17Y, and 17K and outputs an image by forming the image on a paper sheet.

Through the operations described above, the checksum and pixel count value transmitted from the image forming apparatus 10 to the log acquisition apparatus 20 are successively stored on the storage 42 via the high-speed wireless communication controller 28 in the log acquisition apparatus 20.

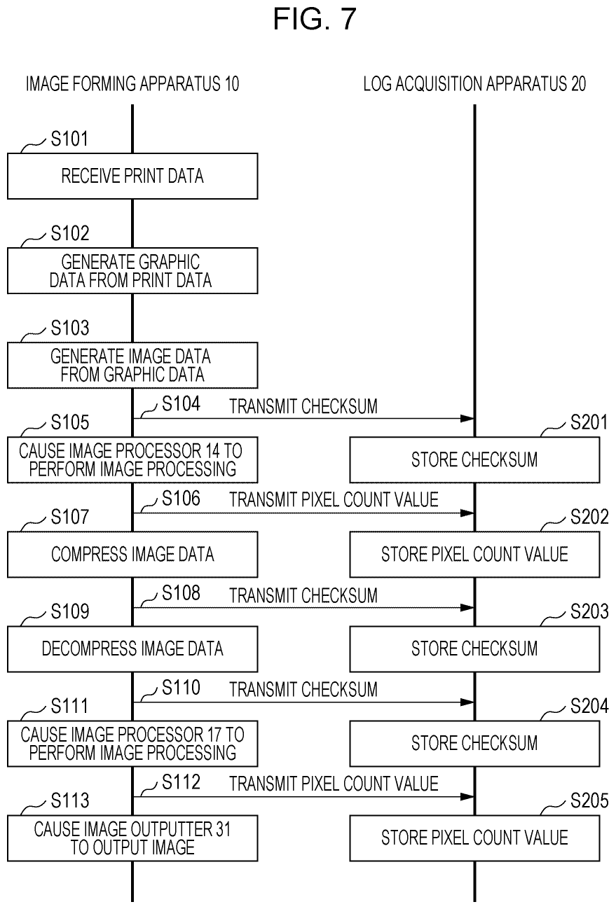

FIG. 7 is a sequence chart of how the log acquisition apparatus 20 stores the checksum and pixel count value transmitted from the image forming apparatus 10. The operations in steps S101 through S113 in FIG. 7 are respectively identical to the operations in steps S101 through S113 in FIG. 6 and the discussion thereof is omitted herein. Referring to steps S201 through S205 in FIG. 7, the checksum and pixel count value successively transmitted from the image forming apparatus 10 are stored on the log acquisition apparatus 20.

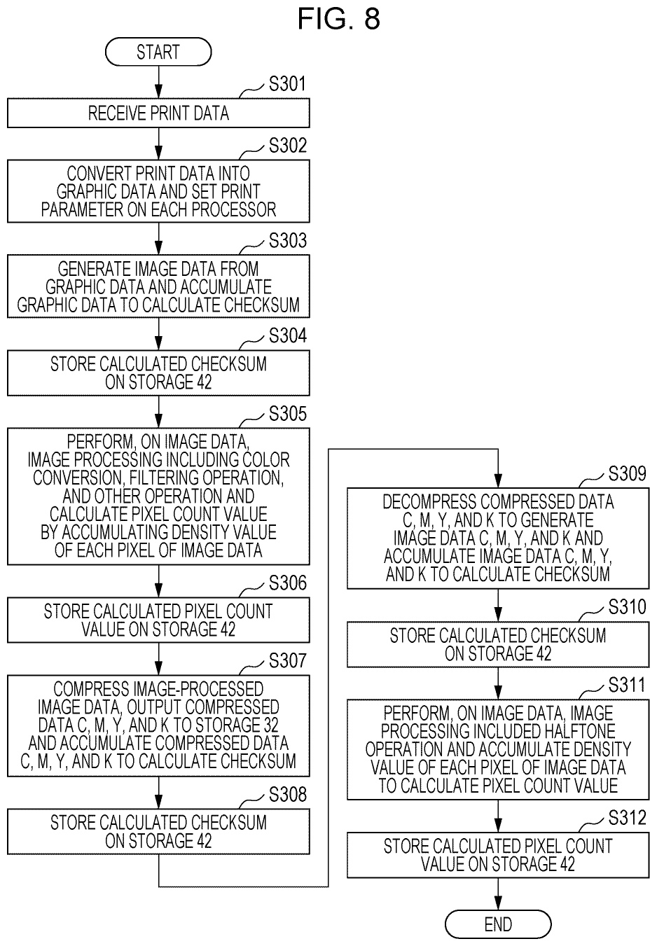

The process of calculating the checksum and pixel count value on the log acquisition apparatus 20 is described with reference to the flowchart in FIG. 8.

In parallel with the printing operation of the image forming apparatus 10, the communication controller 21 receives from outside the same print data as the print data input to the image forming apparatus 10 and causes the storage 42 to store the received print data in step S301. In step S302, the central processing unit 22 analyzes the received print data, generates the graphic data, causes the storage 42 to store the graphic data, and set a parameter on each processor.

In step S303, the drawing unit 23 generates the image data from the graphic data generated by the central processing unit 22 and outputs the generated image data to the image processor 24. The drawing unit 23 accumulates the graphic data to calculate the checksum, and outputs the calculated checksum to the log data acquisition unit 29 via the bus B. The log data acquisition unit 29 causes the storage 42 to store the calculated checksum in step S304.

In step S305, the image processor 24 performs the image processing operations including the color conversion operation and the filtering operation on the image data transmitted from the drawing unit 23 and outputs the image-processed image data to the compression processor 25. The image processor 24 furthermore calculates the pixel count value by accumulating the density value of each pixel of the image data prior to and subsequent to the image processing operations and outputs the calculated image count value to the log data acquisition unit 29 via the bus B. In step S306, the log data acquisition unit 29 causes the storage 42 to store the calculated pixel count value.

In step S307, the compression processor 25 compresses the image data transmitted from the image processor 24 and causes the storage 42 to store the compressed image data. At that time point, the process data color-converted through the color conversion operation performed by the image processor 24 includes four pieces of image data of respective CMYK colors and thus four pieces of compressed data C, M, Y, and K are stored on the storage 42. The compression processor 25 calculates the checksum by accumulating the four pieces of compressed data C, M, Y, and K and outputs the checksum to the log data acquisition unit 29 via the bus B. In step S308, the log data acquisition unit 19 cause the storage 42 to store the calculated checksum.

In step S309, the decompression processors 26C, 26M, 26Y, and 26K decompress the compressed data C, M, Y, and K stored on the storage 42. The decompression processors 26C, 26M, 26Y, and 26K output decompressed image data respectively to the image processors 27C, 27M, 27Y, and 27K. The decompression processors 26C, 26M, 26Y, and 26K thus calculate the checksum by accumulating the decompressed image data C, M, Y, and K and outputs the calculated checksum to the log data acquisition unit 29 via the bus B. The log data acquisition unit 29 causes the storage 42 to store the calculated checksum in step S310.

In step S311, the image processors 27C, 27M, 27Y, and 27K perform image processing operations including a halftone operation on decompressed image data C, M, Y, and K respectively transmitted from the decompression processors 26C, 26M, 26Y, and 26K and outputs the image-processed image data C, M, Y, and K to the timing generator 41. The image processors 27C, 27M, 27Y, and 27K further calculate the pixel count value by accumulating the density value of each pixel of the image data prior to and subsequent to the image processing operations and outputs the calculated pixel count value to the log data acquisition unit 29 via the bus B. In step S312, the log data acquisition unit 29 causes the storage 42 to store the calculated checksum.

In place of the image outputter 31 in the image forming apparatus 10, the timing generator 41 generates the same timing signal as the printing operation and outputs the timing signal to each processor.

Through the operations described above, the checksum and pixel count value calculated by the log acquisition apparatus 20 are successively stored on the storage 42.

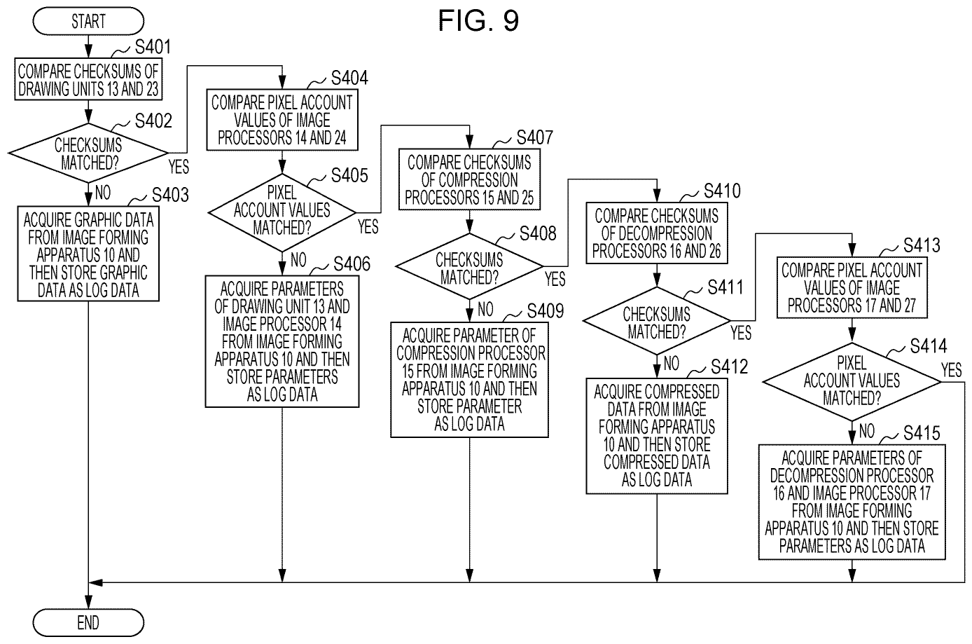

The process of the log acquisition apparatus 20 that acquires log data from the image forming apparatus 10 is described with reference to the flowchart illustrated in FIG. 9.

In step S401, the central processing unit 22 in the log acquisition apparatus 20 compares the checksum calculated by the drawing unit 13 in the image forming apparatus 10 with the checksum calculated by the drawing unit 23 in the log acquisition apparatus 20. The central processing unit 22 determines in step S402 whether the two compared checksums match each other.

If the two checksums are determined to fail to match each other in step S402, the central processing unit 22 determines that the drawing unit 13 determines that the drawing unit 13 malfunctions in processing. In step S403, the log acquisition apparatus 20 acquires the graphic data from the image forming apparatus 10 and stores the graphic data as log data on the storage 42. Specifically, the central processing unit 22 in the log acquisition apparatus 20 causes the high-speed wireless communication controller 28 to request the image forming apparatus 10 to transmit the graphic data. When the image forming apparatus 10 receives the request, the high-speed wireless communication controller 18 retrieves the graphic data from the storage 32 and transmits the graphic data to the log acquisition apparatus 20. The high-speed wireless communication controller 28 in the log acquisition apparatus 20 stores the received graphic data as the log data on the storage 42.

If the two checksums match each other in step S402, the central processing unit 22 in the log acquisition apparatus 20 compares in step S404 the pixel count value calculated by the image processor 14 in the image forming apparatus 10 with the pixel count value calculated by the image processor 24 in the log acquisition apparatus 20. In step S405, the central processing unit 22 determines whether the two pixel count values match each other.

Upon determining that the two pixel count values fail to match each other in step S405, the central processing unit 22 determines that the image processor 24 malfunctions in processing. In step S406, the log acquisition apparatus 20 acquires a parameter in the image processing operation of the image processor 24 from the image forming apparatus 10 and stores the parameter as the log data on the storage 42. Specifically, the central processing unit 22 in the log acquisition apparatus 20 causes the high-speed wireless communication controller 28 to request the image forming apparatus 10 to transmit the parameter in the image processing operation of the image processor 24. When the image forming apparatus 10 receives the request, the high-speed wireless communication controller 18 acquires the parameter in the image processing operation of the image processor 24 and transmits the parameter to the log acquisition apparatus 20. The high-speed wireless communication controller 28 in the log acquisition apparatus 20 stores the parameter in the image processing operation of the image processor 24 as the log data on the storage 42 and thus ends the process.

If the two pixel count vales are determined to match each other in step S405, the central processing unit 22 in the log acquisition apparatus 20 compares in step S407 whether the checksum calculated by the compression processor 15 in the image forming apparatus 10 with the checksum calculated by the compression processor 25 in the log acquisition apparatus 20. In step S408, the central processing unit 22 determines whether the compared checksums match each other.

If the two checksums are determined to fail to match each other in step S408, the central processing unit 22 determines that the compression processor 15 malfunctions in processing. In step S409, the log acquisition apparatus 20 acquires a parameter of the compression processor 15 from the image forming apparatus 10 and stores the parameter as the log data on the storage 42. Specifically, the central processing unit 22 in the log acquisition apparatus 20 causes the high-speed wireless communication controller 28 to request the image forming apparatus 10 to transmit the parameter of the compression processor 15. When the image forming apparatus 10 receives the request, the high-speed wireless communication controller 18 acquires the parameter of the compression processor 15 and transmits the parameter to the log acquisition apparatus 20. The high-speed wireless communication controller 28 in the log acquisition apparatus 20 stores the received parameter of the compression processor 15 as the log data on the storage 42.

When the two checksums are determined to match each other in comparison in step S408, the central processing unit 22 in the log acquisition apparatus 20 compares in step S410 the checksum calculated by the decompression processors 16C, 16M, 16Y, and 16K in the image forming apparatus 10 with the checksum calculated by the decompression processors 26C, 26M, 26Y, and 26K in the log acquisition apparatus 20. In step S411, the central processing unit 22 determines whether the two compared checksums match each other.

When the two checksums are determined to fail to match each other in step S411, the central processing unit 22 determines that the decompression processors 16C, 16M, 16Y, and 16K malfunctions in processing. In step S412, the log acquisition apparatus 20 acquires the compressed data C, M, Y, and K from the image forming apparatus 10 and stores the compressed data C, M, Y, and K on the storage 42. Specifically, the central processing unit 22 in the log acquisition apparatus 20 causes the high-speed wireless communication controller 28 to request the compressed data C, M, Y, and K from the image forming apparatus 10. When the image forming apparatus 10 receives the request, the high-speed wireless communication controller 18 retrieves the compressed data C, M, Y, and K from the storage 32 and transmits the compressed data C, M, Y, and K to the log acquisition apparatus 20. The high-speed wireless communication controller 28 in the log acquisition apparatus 20 stores the received compressed data C, M, Y, and K as the log data on the storage 42.

If the two checksums are determined to match each other in step S411, the central processing unit 22 in the log acquisition apparatus 20 compares in step S413 the pixel count value calculated by the image processors 17C, 17M, 17Y, and 17K in the image forming apparatus 10 with the pixel count value calculated by the image processors 27C, 27M, 27Y, and 27K in the log acquisition apparatus 20. The central processing unit 22 then determines in step S414 whether the two pixel count values match each other.

If the two pixel count values are determined to fail to match each other in step S414, the central processing unit 22 in the log acquisition apparatus 20 determines that the image processors 17C, 17M, 17Y, and 17K malfunction in processing. In step S415, the log acquisition apparatus 20 acquires parameters of the decompression processors 16C, 16M, 16Y, and 16K and image processors 17C, 17M, 17Y, and 17K from the image forming apparatus 10 and stores the parameters as the log data on the storage 42. Specifically, the central processing unit 22 in the log acquisition apparatus 20 causes the high-speed wireless communication controller 28 to request the parameters of the decompression processors 16C, 16M, 16Y, and 16K and image processors 17C, 17M, 17Y, and 17K from the image forming apparatus 10. When the image forming apparatus 10 receives the request, the high-speed wireless communication controller 18 in the image forming apparatus 10 acquires the parameters of the decompression processors 16C, 16M, 16Y, and 16K and image processors 17C, 17M, 17Y, and 17K and then transmits the parameters to the log acquisition apparatus 20. In response, the high-speed wireless communication controller 28 in the log acquisition apparatus 20 stores the received parameters of the decompression processors 16C, 16M, 16Y, and 16K and image processors 17C, 17M, 17Y, and 17K as the log data on the storage 42 and then completes the process.

If the two pixel count values are determined to match each other in step S414, the central processing unit 22 completes the process.

Through those processes, even when the checksum and pixel count value calculated at the operation phase of each of the image processing operations fail to match each other between the image forming apparatus 10 and the log acquisition apparatus 20, the process data at that time point is transmitted from the image forming apparatus 10 to the log acquisition apparatus 20 and then stored as the log data on the log acquisition apparatus 20. When a formed image has any fault even with the image forming apparatus 10 not malfunctioning in the image forming process, the log data in the image forming process is acquired and stored.

The image forming apparatus 10 of the exemplary embodiment transmits the checksum, pixel count value, and log data, not via a bus A that is used in standard printing operation. The image forming apparatus 10 of the exemplary embodiment may thus acquire the log data without dropping performance of the standard printing operation.

According to the exemplary embodiment, the image forming apparatus 10 and log acquisition apparatus 20 are connected to each other via the high speed wireless communication network with shorter delay time. The log acquisition apparatus 20 may thus acquire the log data on the image forming apparatus 10 on a real-time basis and may thus acquire a large volume of log data.

Since the log acquisition apparatus 20 stores the log data in the exemplary embodiment, a resource of the image forming apparatus 10, such as a capacity of storage, is not consumed and the acquired log data may be stored for a long period of time as old log data.

The log acquisition apparatus 20 without the image outputter 31 is free from effects, such as noise and voltage variations from the image outputter 31. According to the exemplary embodiment, a fault in an image caused by such noise and voltage variations may be more easily detected.

In the exemplary embodiment above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

The “system” in the exemplary embodiment may be configured to include a single apparatus or multiple apparatuses.

The disclosure may be applicable to a program and/or a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including:
an image forming system; and
a log acquisition system,
wherein the image forming system includes: an image outputter; and
a first processor configured to:
   perform multiple image processing operations that convert print data, input to the image forming system, into image data that the image outputter outputs to a recording medium, while calculating and successively outputting a first feature value externally that is used to confirm data identity of process data that is generated at an operation phase of each of the image processing operations, and
wherein the log acquisition system includes a second processor configured to:
   perform, on print data identical to the print data input to the image forming system, multiple image processing operations respectively identical to the image processing operations performed by the image forming system, while calculating a second feature value that is used to confirm data identity of process data that is generated at an operation phase of each of the image processing operations; acquire from the image forming system the first feature value at the operation phase of each of the image processing operations; and when the acquired first feature value is different from the second feature value, acquire, from the image forming system, data used to analyze the image processing operations and store the data as history information.
      (((2)))

In the information processing system according to (((1))), the first processor is configured to set, to be the first feature value, a value that is calculated by performing a calculation operation on the process data through a preset calculation method, and the second processor is configured to set, to be the second feature value, a value that is calculated by performing on the process data a calculation operation identical to the calculation operation through the preset calculation method.

(((3)))

In the information processing system according to (((2))), each of the first feature value and the second feature value is a checksum that is obtained by accumulating the process data or a density cumulative value that is obtained by accumulating a density value of each pixel.

(((4)))

In the information processing system according to one of (((1))) through (((3))), the image processing operations convert the print data into raster image data that is used to output an image on a recording medium on multiple image forming units for respective colors forming the image outputter.

(((5)))

In the information processing system according to (((4))), the image processing operations converting the print data into the raster image data include a color conversion operation that converts the print data into image data on a per color basis used by the image outputter and a halftone operation used to represent halftone.

(((6)))

In the information processing system according to one of (((1))) through (((5))), the second processor is configured to acquire from the image forming system the first feature value at the operation phase of each of the image processing operations via a wireless communication network.

(((7)))

A program causing a computer to execute a process including: performing multiple image processing operations that convert print data, input to an image forming system, into image data that an image outputter outputs to a recording medium, while calculating and successively outputting a first feature value externally that is used to confirm data identity of process data that is generated at an operation phase of each of the image processing operations;
performing in a log acquisition system, on print data identical to the print data input to the image forming system, multiple image processing operations respectively identical to the image processing operations performed by the image forming system, while calculating a second feature value that is used to confirm data identity of process data that is generated at an operation phase of each of the image processing operations; and
transmitting the first feature value at the operation phase of each of the image processing operations from the image forming system to the log acquisition system; and when the first feature value is different from the second feature value, transmitting from the image forming system to the log acquisition system, data used to analyze the image processing operations and storing the data as history information.

What is claimed is:

1. An information processing system comprising:
an image forming system; and
a log acquisition system,
wherein the image forming system includes: an image outputter; and
a first processor configured to:
perform a plurality of image processing operations that convert print data, input to the image forming system, into image data that the image outputter outputs to a recording medium, while calculating and successively outputting a first feature value externally that is used to confirm data identity of process data that is generated at an operation phase of each of the image processing operations, and
wherein the log acquisition system includes a second processor configured to:
perform, on print data identical to the print data input to the image forming system, a plurality of image processing operations respectively identical to the image processing operations performed by the image forming system, while calculating a second feature value that is used to confirm data identity of process data that is generated at an operation phase of each of the image processing operations; acquire from the image forming system the first feature value at the operation phase of each of the image processing operations; and when the acquired first feature value is different from the second feature value, acquire, from the image forming system, data used to analyze the image processing operations and store the data as history information.

2. The information processing system according to claim 1, wherein the first processor is configured to set, to be the first feature value, a value that is calculated by performing a calculation operation on the process data through a preset calculation method, and the second processor is configured to set, to be the second feature value, a value that is calculated by performing on the process data a calculation operation identical to the calculation operation through the preset calculation method.

3. The information processing system according to claim 2, wherein each of the first feature value and the second feature value is a checksum that is obtained by accumulating the process data or a density cumulative value that is obtained by accumulating a density value of each pixel.

4. The information processing system according to claim 1, wherein the image processing operations convert the print data into raster image data that is used to output an image on a recording medium on a plurality of image forming units for respective colors forming the image outputter.

5. The information processing system according to claim 4, wherein the image processing operations converting the print data into the raster image data include a color conversion operation that converts the print data into image data on a per color basis used by the image outputter and a halftone operation used to represent halftone.

6. The information processing system according to claim 1, wherein the second processor is configured to acquire from the image forming system the first feature value at the operation phase of each of the image processing operations via a wireless communication network.

7. A non-transitory computer readable medium storing a program causing a computer to execute a process comprising:
performing a plurality of image processing operations that convert print data, input to an image forming system, into image data that an image outputter outputs to a recording medium, while calculating and successively outputting a first feature value externally that is used to confirm data identity of process data that is generated at an operation phase of each of the image processing operations;
performing in a log acquisition system, on print data identical to the print data input to the image forming system, a plurality of image processing operations respectively identical to the image processing operations performed by the image forming system, while calculating a second feature value that is used to confirm data identity of process data that is generated at an operation phase of each of the image processing operations; and
transmitting the first feature value at the operation phase of each of the image processing operations from the image forming system to the log acquisition system; and when the first feature value is different from the second feature value, transmitting from the image forming system to the log acquisition system, data used to analyze the image processing operations and storing the data as history information.

8. A method comprising:
performing a plurality of image processing operations that convert print data, input to an image forming system, into image data that an image outputter outputs to a recording medium, while calculating and successively outputting a first feature value externally that is used to confirm data identity of process data that is generated at an operation phase of each of the image processing operations;
performing in a log acquisition system, on print data identical to the print data input to the image forming system, a plurality of image processing operations respectively identical to the image processing operations performed by the image forming system, while calculating a second feature value that is used to confirm data identity of process data that is generated at an operation phase of each of the image processing operations; and
transmitting the first feature value at the operation phase of each of the image processing operations from the image forming system to the log acquisition system; and when the first feature value is different from the second feature value, transmitting from the image forming system to the log acquisition system, data used to analyze the image processing operations and storing the data as history information.
